(19) United States
(12) Patent Application Publication
(10) Pub. No.: US 2011/0191991 A1
(43) Pub. Date: Aug. 11, 2011

(54) COMPOSITE EARRING BACKER AND METHOD OR RETAINING AN EARRING WITH COMPOSITE BACKER

(76) Inventor: Jean Jacques Meneau, Cross Junction, VA (US)

(21) Appl. No.: 12/998,317

(22) PCT Filed: Jul. 30, 2010
(86) PCT No.: PCT/US2010/002140

§ 371 Date: Apr. 6, 2011

Related U.S. Application Data
(60) Provisional application No. 61/273,463, filed on Aug. 6, 2009.

(51) Int. Cl. A44C 7/00; B23P 11/02

(52) U.S. Cl. 24/705; 29/450

(57) ABSTRACT

A composite jewelry retaining element for a post is disclosed which includes a first inner core part that is a conventional retainer such as a butterfly clamp, spring biased clutch or screw back device. The inner core part is enveloped by an elastomeric section. The elastomeric section has a tubular passage that is sized slightly smaller than an aperture provided through the conventional retainer and that receives an earring post. The post is thereby retained by both the conventional retainer element and a gripping force imposed by the elastomeric section which is created by providing the passage that is slightly smaller than the post.

The present invention relates to a new and useful retainer element for a post of an earring or for other jewelry such as pins or broaches. The Applicant claims the benefit of U.S. Application No. 61/273,463.

### FIELD AND BACKGROUND OF THE INVENTION

The use of a post and clamp is a common manner to retain ornaments that are worn on the ears such as earrings. In general and conventionally, any ornament that is worn on the ear is referred to as an “earring” or “ear ring,” notwithstanding the actual geometric shape of the device. Posts used with earrings are often straight rods which extend from the ornamental element of the jewelry piece and through a hole that has been pierced through the ear. On the opposite side of the ear the post is often engaged to retain the earring in place. Some earrings designs, referred to as a French Wire posts, use a post that fits through an aperture in the ear and then extends back downward. The French Wire post design does not necessarily require the use of a separate retainer element.

There have been a number of devices developed over the years that will hold or engage a post including clasps, clutches or clamps. A first arrangement used in connection with conventional straight posts is referred to as a butterfly clamp. The butterfly clamp includes a flat disk that is provided a central aperture. Extending from opposite laterals sides of the flat disk are opposite resilient arms that loop back toward a central axis that is defined by the central aperture. The arms will flex toward the point of attachment location and are biased toward the central axis. These opposite arms may engage a post of an earring that extends though the central aperture and along the central axis in a frictional engagement thereby functioning to retain the earring.

In an alternative earring retaining arrangement, referred to as a screw back, a post further includes threads that are provided along the exterior surface of the post, like a bolt. These threads may engage opposite threads that are provided on an inner diameter surface of a central aperture through a disk and, a second aperture that is provided through the apex of an arch that extends from one side of the disk to the opposite side. This arrangement is often employed when the user is wearing valuable jewelry such as diamonds and is conventionally thought to be a more secure manner in which to retain the earrings. While this technique has some advantages, the threads can nevertheless become disengaged during normal wear.

In another prior art device a clasp is used that includes a disk with a hole provided there through for receiving a post, and a pair of spring-loaded pushbuttons. As the button is pushed, a coiled spring increases its diameter and allows a post to freely slide through the device. When the coiled spring is permitted to return to a relaxed position, its diameter is reduced and its interior surface engages the sidewalls of a post.

The use of elastic materials to retain earrings has been disclosed in the prior art, including conventional rubber. However, conventional rubber is prone to cracking, is not recognized as hypoallergenic and has different resilient properties when compared to silicone elastomers or silicone rubber, such as polydiphenylsiloxane. In addition, conventional rubber is not transparent. The prior art also discloses earring backings made from nylon and other synthetic resin materials. These devices do not contemplate using a conventional earring nut made from metal in combination with a silicone material that encapsulates a conventional metallic spring biased arm, screw back or other engagement device. Other types of jewelry clutches which represent prior art to the subject invention of which the applicant is aware are disclosed in the U.S. patents to Elkin U.S. Pat. No. 4,907,425; Chernow, U.S. Pat. No. 3,698,044; Gagnon, U.S. Pat. No. 3,945,089; Connelly et al, U.S. Pat. No. 4,630,452; and Nitsche, U.S. Pat. No. 4,723,421. A number of these references disclose the use of a synthetic resin material to engage an earring post. However, the clutches disclosed in some of these references have been reported to be prone to inadvertently slipping off the posts of jewelry items.

In general, the portion of the earring penetrating the earlobe is made very small to minimize tissue exposure and the supporting compression about the opening. It is also desirable to minimize sharp edges and surfaces, which could cut or scrape the skin surface in connection with the earring support structure. A further problem with earring retainers relates to the use of materials that may cause skin irritation. In connection with pierced earrings, some efforts to reduce the problems with skin irritation have included proving non-allergenic coatings, such as gold, to the portions of the earrings which contact the skin. However, such plating may wear-off and gold is rarely plated in its pure form because of its relative softness. Instead, gold-nickel alloys are commonly used, but nickel can be the source of an allergic reaction. Further, it has been reported that a significant number of people suffer an allergic response to tissue contact with any metallic substance.

The increased popularity of providing multiple piercing and a variety of ear piercing types that include cartilage piercing in such areas of the outer ear as the conch, the daith, the orbital and the rook, has contributed to the need for improved retention devices that minimize the possibility wherein the post will come into contact with the skin, hair and the frames of eyeglasses that rest behind the ear.

### SUMMARY OF THE INVENTION

The present invention relates to an improved manner to that uses a conventional butterfly mechanical earring backing member or other mechanical engagement devices as described above in combination with an exterior elastomeric part that provides an additional retention feature in the form of a frictional engagement of the post that is enabled by the elastomeric material's resiliency. This frictional engagement of the post is supplemental to the metallic retention members engagement as described above. The device may be used in combination with conventional screw back earring nuts, clutches or other spring loaded retainer devices as described herein. The device may also be used as a safety clutch to help retain pins and brooches. According to embodiments of the invention, the post terminates within the elastomeric portion and thereby the device serves to prevent contact between the post and the wearer's skin, hair and eyeglasses.

### BRIEF DESCRIPTION OF THE DRAWINGS

FIG. 1 is a perspective view of a first embodiment of the invention.

FIG. 2 is a bottom view of the embodiment depicted in FIG. 1.

FIG. 3 is a top view of the embodiment depicted in FIG. 1.

FIG. 4 is a side view of the embodiment depicted in FIG. 1.

FIG. 5 is a side sectional view of the embodiment depicted in FIG. 1.

FIG. 6 is a side view of the embodiment depicted in FIG. 1

FIG. 7 is a perspective view of a second embodiment of the invention.

FIG. 8 is a bottom view of the second embodiment depicted in FIG. 7.

FIG. 9 is a top view of the embodiment depicted in FIG. 7.

FIG. 10 is a side view of the embodiment depicted in FIG. 1.

FIG. 11 is a side sectional view of the embodiment depicted in FIG. 7.

FIG. 12 is a side view of the embodiment depicted in FIG. 7.

FIG. 13 is a side sectional view of a further embodiment of the invention.

FIG. 14 is bottom view of the embodiment depicted in FIG. 13.

FIG. 15 is a top view of the embodiment depicted in FIG. 13.

FIG. 16 is a perspective view of the embodiment depicted in FIG. 13.

FIG. 17 is a side sectional view of yet a further embodiment of the invention.

FIG. 18 is bottom view of the embodiment depicted in FIG. 17.

FIG. 19 is a top view of the embodiment depicted in FIG. 17.

FIG. 20 is a perspective view of the embodiment depicted in FIG. 17.

FIG. 21 is a side sectional view of a further embodiment of the invention.

FIG. 22 is bottom view of the embodiment depicted in FIG. 21.

FIG. 23 is a top view of the embodiment depicted in FIG. 21.

FIG. 24 is a perspective view of the embodiment depicted in FIG. 21.

FIG. 25 is a side sectional view of a further embodiment of the invention depicting an earring post that terminates within the elastomeric portion of the device.

FIG. 26 is a side sectional view of a screw back retention element in combination with an elastomeric outer covering.

### DETAILED DESCRIPTION

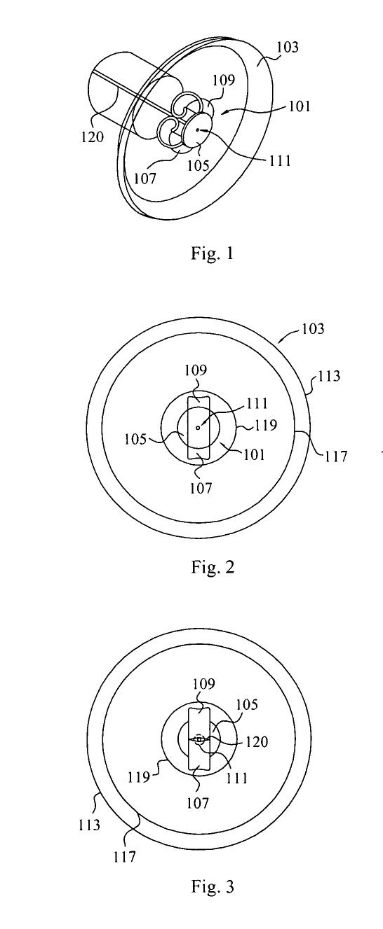

Now referring to FIG. 1 in a first embodiment a conventional butterfly clamp earring backer 101 is depicted encapsulated within a silicone cover or capsule 103. Butterfly clamp 101 includes a flat disk section 105 and opposite arms 107 and 109. An aperture 111 is provided through disk 105 which is sized to receive a post from an earring. In preferred embodiments the butterfly clamp is made from gold or silver.

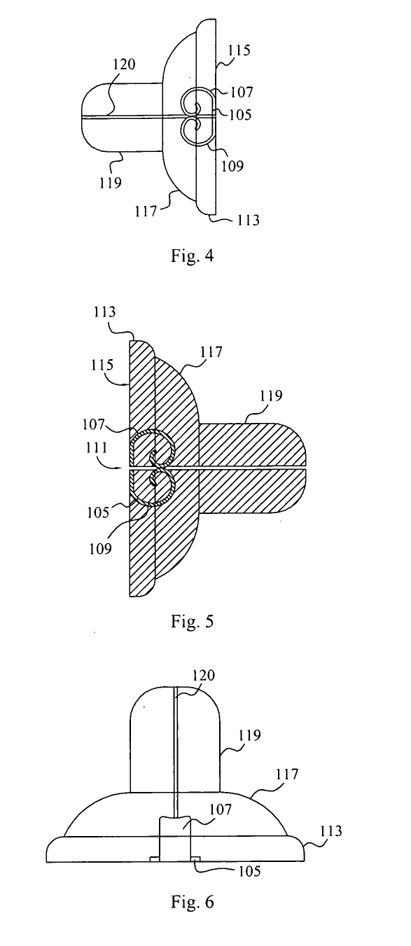

Referring now to FIG. 2, a bottom view of the device, aperture 111 is provided through the center of the disk. In a preferred embodiment aperture 111 through disk 105 has a diameter of approximately 0.9 mm. It is sized to be able to receive the posts provided on conventional earrings. As best seen in FIG. 4, immediately adjacent to this aperture is a passage 120 that extends though a first region 113 of capsule 103. This first region 113 has a circular planar surface 115 that has a diameter of approximately 12 mm and extends in an axial direction for approximately 1 mm. The planar surface 115 is designed to engage the rear of an earlobe. In preferred embodiments the diameter of the passage through capsule 103 has a diameter of approximately 0.35 mm to 0.40 mm and is therefore smaller than the diameter of aperture 111.

FIG. 3 is a top view of the device depicted in FIG. 1 and shows that in a relaxed position the arms are positioned next to one another. As shown in FIG. 3, aperture 111 through disk portion 105 is slightly larger than passage 120. When the post is inserted through the passage 120, it will displace both the sidewalls of the passage 120 laterally and opposite arms 109 and 107. The arms will therefore provide a biasing force against the post and serve to retain the earring. This biasing force is supplemented by the elastomeric material in which the metallic element is surrounded.

As best seen in FIG. 5, passage 120 extends from first region 113 to second region 117 of capsule 103 where it intersects with inwardly-facing biased arms 107 and 109. The second region 117 has an axial dimension of approximately 2 mm and a diameter that gradually diminishes from approximately 10 mm where it extends from the first region to about 4 mm were it intersects with a third regions 119. The third region 119 has an axial dimension of about 5 mm. The axial dimension of the passage 120 that extends through region 113, 117 and 119 is approximately 8 mm. In preferred embodiments the diameter of passage 120 is sized slightly smaller than the diameter of a post of an earring used with the retainer.

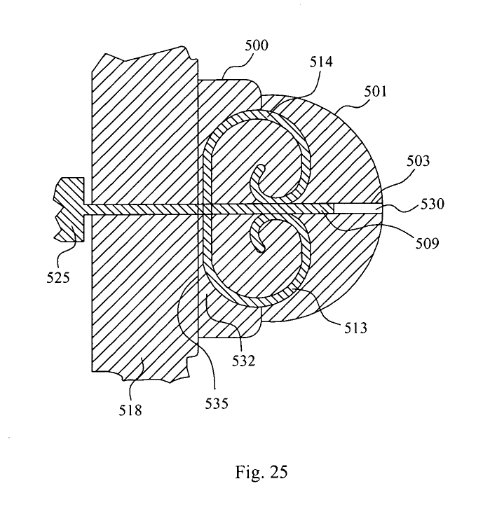

FIGS. 1-5 depict an embodiment wherein the surface of the disk 105 is exposed to the external environment and may engage the rear of the ear lobe. In a contemplated alternative embodiment of the invention, as depicted in FIG. 25 a thin sheet 532 of the silicone cover 500 extends in front of disk section of the butterfly clamp 105 to cover the disk and therefore provide a barrier surface 535 that contacts the ear lobe 518.

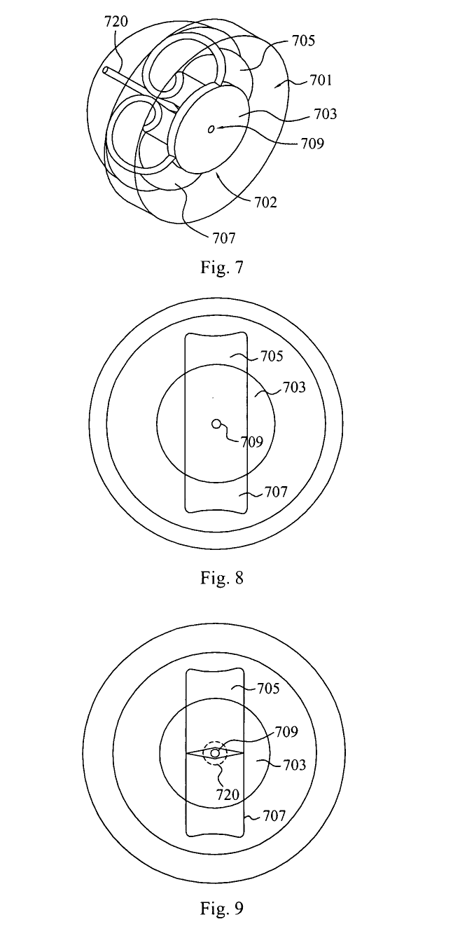

FIG. 7 depicts a second embodiment of the invention that is characterized by a capsule 701 that surrounds a butterfly clamp 702. Like the embodiment depicted in FIGS. 1-6, the butterfly clamp includes flexible arms 707 and 705. A central aperture 709 is provided through the center of disk 703 that receives the post of an earring. FIG. 8 is a bottom view of the device and includes a depiction of aperture 709 through disk 703 and opposite arms 707 and 705. FIG. 9, a top view of the device depicted in FIGS. 7-8 further depicts passage 709 that extends through the silicone capsule and is smaller than the larger than the aperture 709. (The aperture 709 and passage 720 are not drawn to scale).

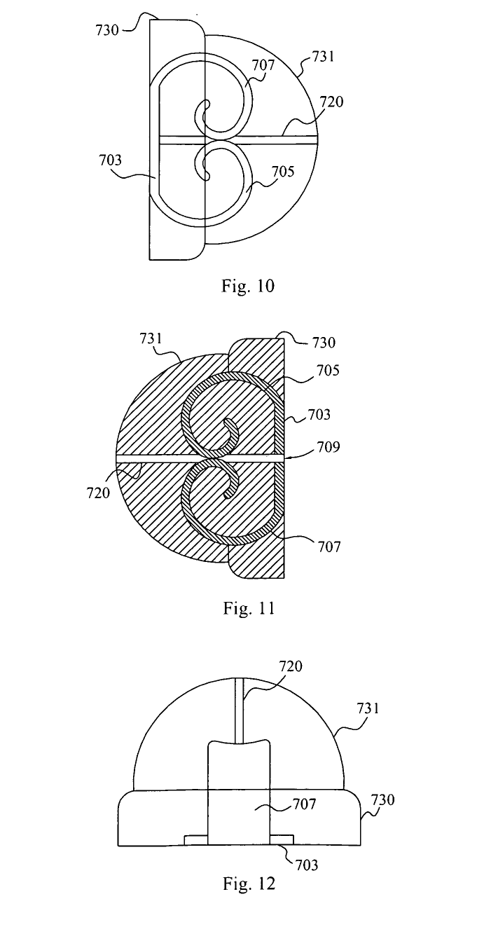

Now referring to FIG. 10, the capsule of the second embodiment includes a first section 730 which includes a planar surface designed to engage the rear of the ear lobe. Extending from section 730 is domed shaped section 731 which has a rounded profile. The side view further depicts the disk 703, and arms 705 and 709 which extend from the disk. As seen in FIG. 11, a sectional view of the second embodiment, the passage through disk 703 joins with passage 720 which extends axially through the device. FIG. 12, a side view of the second embodiment, depicts arm 707 that extends from disk 703.

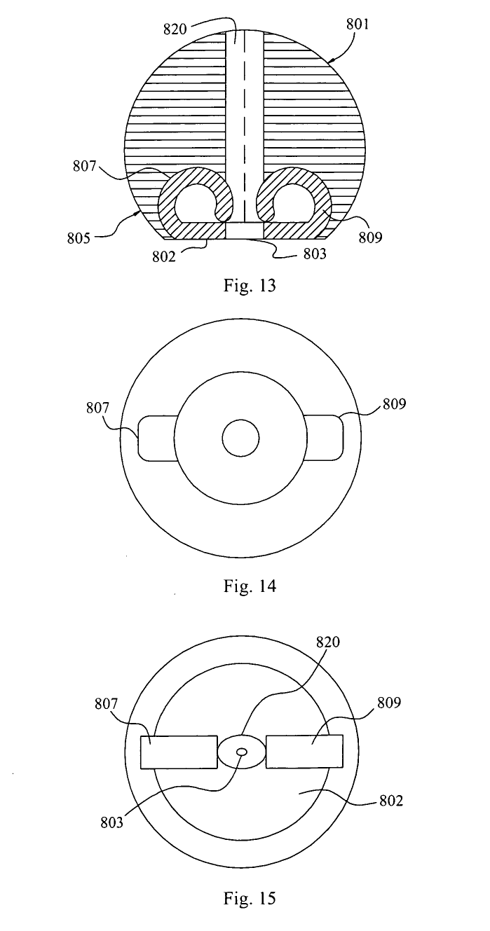

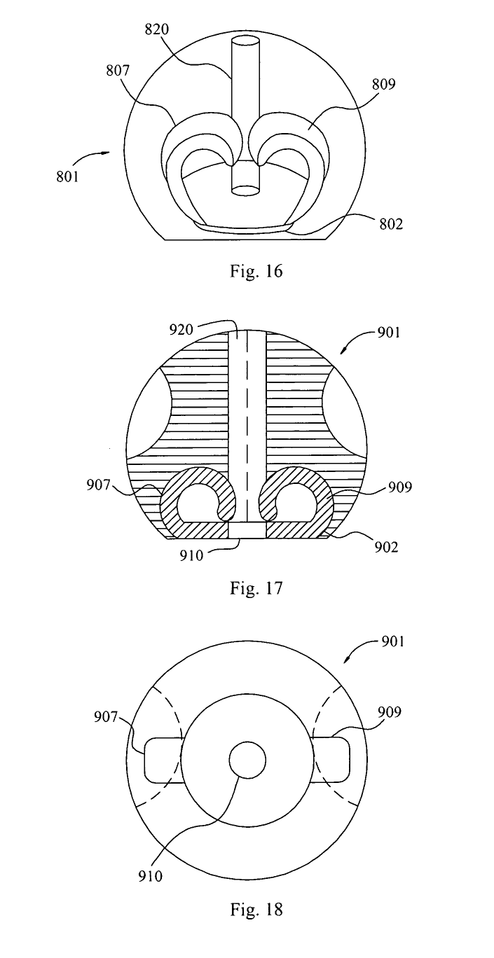

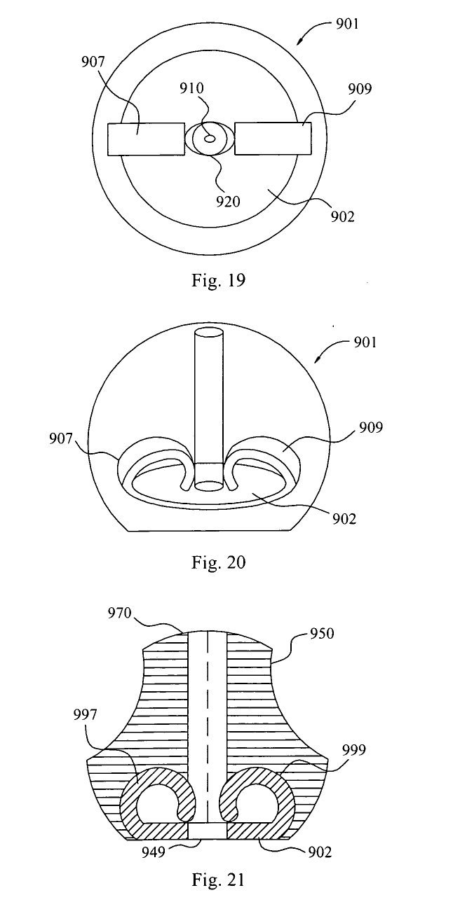

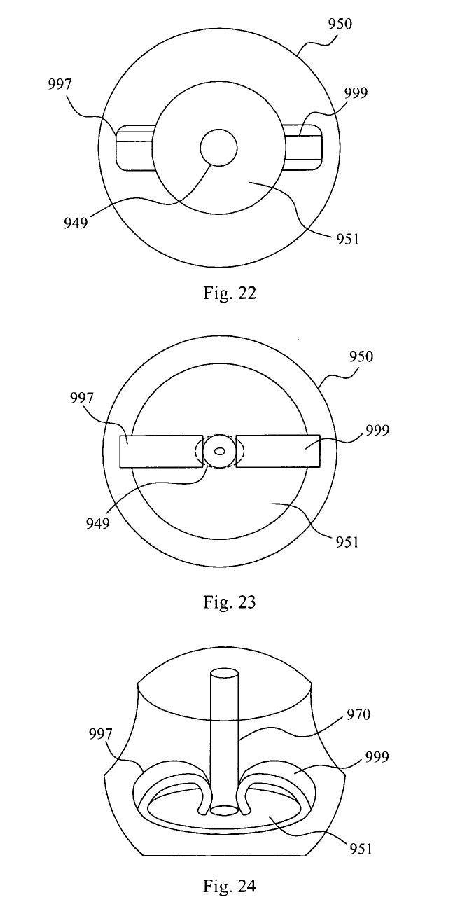

As discussed above, the first and second embodiments depicted a bullet shaped and a generally hemispherical silicone capsule. It is contemplated that other shapes may be beneficially provided including semispherical shapes, such as set forth in FIGS. 13-16, modified semispherical shapes, such as that depicted in FIGS. 17-20, and modified cylinders such as those found in FIGS. 21 through 24. FIGS. 13-16 depict a semispherical silicon capsule 801 that envelopes a butterfly clamp with opposite arms 807 and 809 extending from disk 802 which includes aperture 803. Central passage 820 receives a post from an earring.

FIGS. 17-20 depict another embodiment wherein a semispherical capsule 901 includes opposite indentations to allow for easier handing by the user. Like the other embodiments the device includes a butterfly clamp with opposite arms 907 and 909 and disk 902 having a central aperture 910. FIGS. 21-24 depict a further embodiment of the invention wherein the capsule 950 comprises a modified cylinder. Like the previous embodiments the cylinder contains a butterfly clamp having opposite arms 997 and 999, a disk 902, a central aperture 849 through disk 902 and a passage 970. Other contemplated shapes include cubes, pyramids, and hexagonal cylinders.

The capsules that surrounds the metallic parts, such as capsule 103 is made from an elastomeric material. The capsule functions to provide a barrier between the metallic parts and the skin of the user and cooperates with the metallic elements by providing an additional basing force when the arms are displaced from a relaxed position. Covering the metallic clamp element also prevents the edges of the clamp from contacting the skin and hair of the user. In addition, the tubular passage provided through the capsule provides a separate and independent frictional engagement with an earring post or pin that is received through the passage.

The silicone rubber material that makes up the capsule can be provided in a variety of different shapes as disclosed herein. In preferred embodiments, the silicone is comprised of a silicone rubber and is transparent. As such, the device allows the visual inspection of the metallic portion found inside the silicone portion. This use of a transparent material has the advantage of allowing the users to see the metallic portion of the earring so that the user can easily locate the passages provided through the device and properly align the device with the post. The transparent property allows the user to see the internal retainer element, such as a butterfly clamp, which aids in the orientation process. The use of silicone rubber is also lightweight and can be comfortably handled by the wearer and provides a protective and comfortable barrier between the metallic elements and the neck.

Now referring to FIG. 25, the portion of the elastomeric section that is distal to surface 535 that is in contact with the earlobe 518 is extended to a length that is longer than earring post 509. The post 509 therefore extends from the ornamental portion of the earring 525, through the earlobe 518 and into the improved retainer, through an aperture provided through the butterfly clamp, and is then engaged by opposite arms 513 and 514, causing the arms to be displaced in a radial direction from the axis defined by post 509. As shown, the post 509 then terminates within passage 530 and does not extend through the part. As such the end of the post is prevented from engagement with the neck, hair or glasses.

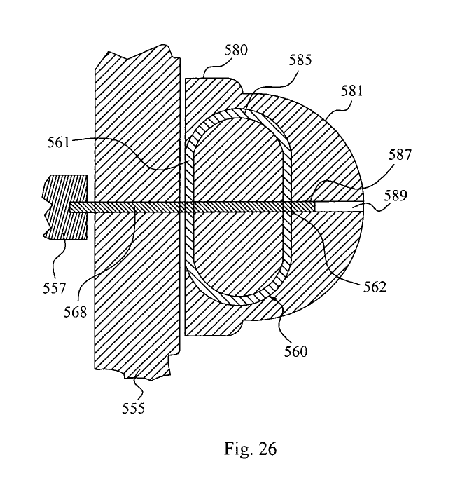

Yet a further embodiment of the invention is depicted in FIG. 26. This embodiment employs a screw-back earring retainer element 560 that is enveloped by the silicone capsule section 580 and 581. The screw-back device includes arm 585 that extends from one side of disk 561 and terminates on the opposite side of the disk. Provided through is the disk are threads at a central opening and threads through the arm 585. These threads are engaged by opposite threads 587 that are provided on the post 568 of an earring. The earring includes ornamental part 557 from which extends post 568. The post extends through the ear lobe 555 and then into the retainer device.

The embodiment depicted in FIG. 26 shows a post 568 that terminates within the elastomeric material of the elastomeric material. This arrangement protects the wearer from contact with the post which may be uncomfortable or cause irritation.

Now referring to the embodiments of FIGS. 7-12 and FIGS. 13-16, the semi-spherical or hemispherical shape provides a unique and distinctive ornamental look that resembles a bead of water on the ear. The metallic portion of the retainer element that is contained within the transparent capsule allows the penetration of light through the earring and then allows for the reflection of light from the metallic portion and back through the silicone rubber resulting in an appealing appearance. The transparent feature also allows the inspection of the metallic retainer part and the user can match the metallic portion of the earring nut with the same material used in connection with the post and earrings.

According to the construction of the present invention, the silicone rubber material is external to the metallic portion. This constructional allows the internal metallic retainer element to provide a framework or internal structure for the silicone part. The geometry of the metallic internal clamp structure also serves to mechanically secure the silicone rubber part to the metallic part. In this regard, for example, if the silicone rubber part only engaged a planer disk surface of a metallic clutch, the parts would be prone to separate from one another along the planar surface.

The use of silicone rubber in the capsule is preferred because it considered highly inert and therefore adverse reactions to the device is minimized. As disclosed in FIG. 25, the device is constructed so that the silicone rubber portion surrounds the metallic inner portion and therefore provides an external barrier between the metallic portion of the retainer element and the external environment.

While a transparent silicone rubber is preferred, in other embodiments a dye or other colorant may be provided to the silicone rubber to color the silicone portion of the device. For example, the silicone may be provided with any color to match or contrast with the ornament or a metallic color to blend in with the metallic portion.

Silicone rubber withstands high temperatures without decomposing, has a wide operating temperature range, extremely good resistance to weathering, excellent electrical properties, good resistance to oils, is easily colored, has a low level of toxicity and can be made with a proper elasticity and hardness. Some of the properties of silicone that makes it appropriate and useful for the present application are its thermal stability (constancy of properties over a wide operating range of −100 to 250° C.), its resistance to oxygen, ozone and sunlight, its flexibility, it does not adhere to other materials after curing, and its low chemical reactivity and toxicity properties. The hardness of a material can be measured using a shore durometer. A rubber band has a reported shore durometer hardness of between about 25 and an automobile tire has a value of about 70 and a soft polyurethane skateboard wheel about 75. In a preferred embodiment the elastomeric portion of the device has a Shore durometer value between about 25 and 75.

In the preferred embodiment the capsule is comprised of silicone rubber because it is inert, has good flexibility which allows the gripping of the earring post and can be provided in transparent forms. While silicone rubber is preferred, other elastomeric polymers may be advantageously used with the invention. In addition, it is contemplated that other synthetic resins with sufficient elasticity may be used in connection with the invention such as polyurethane, polyethylene and nylon.

In embodiments of the invention the metallic portion of the product is made in 14K gold, 18K gold, white gold, yellow gold and sterling silver. In an embodiment, the diameter of the planar surface that is designed to be placed against the back of the earlobe is approximately 5 millimeters and the distance from the front flat opening that receives the post to the rear opening is approximately 3.8 to 3.9 mm.

The device can be used in connection with a wide variety of earrings including straight post, screw post, wire earring or, half hoop earring posts. In addition, the device can be used in connection with Omega Back arrangements, lever back, French Wire and hoop earrings. The post is inserted through the metallic part of the earnut and through a passage provided through the silicone rubber section. In preferred embodiments, the diameter of the passage through the silicone portion of the device is made slightly smaller than the diameter of the post. This relationship results in the silicone expanding to allow the post to penetrate though the passage. This relationship results in a frictional engagement between the post and the silicone part of the device.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which embodiments of the invention are illustrated.

While specific embodiments of the invention have been shown and described in detail to illustrate the application of the principles of the invention, it will be understood that the invention may be embodied otherwise without departing from such principles.

What is claimed is:

1. A composite jewelry retaining element comprising a first inner core part and an outer capsule section, said inner core part comprising a metallic retainer element, said metallic element further comprising an aperture, said aperture having a diameter sized to receive a post of an earring and said metallic element further comprising a post engagement element, and said outer capsule section comprised of an elastomeric material, said elastomeric material surrounding and enveloping said post engagement element, said outer capsule section further comprising a tubular passage, said tubular passage defining an axis, said passage extending from a first planar surface to an opposite surface, and said passage having a diameter less than the diameter of said aperture and said passage comprising a gripping surface.

2. The device recited in claim 1 wherein said post engagement element comprises a butterfly clam, said clamp further comprises resilient opposite arms and said arms have surfaces that intersect with said passage and are adapted to engage a post inserted through said aperture and passage, and said arms may be displaced in a radial direction from said axis.

3. The device recited in claim 1 wherein said post engagement element comprises a screw back earring retainer device.

4. The device recited in claim 1, wherein said capsule completely surrounds said metallic element.

5. The device recited in claim 1 wherein said metallic element is comprised of gold.

6. The device recited in claim 1 wherein said metallic element is comprised of silver.

7. The device recited in claim 1 wherein said elastomeric materials comprises silicone rubber.

8. The device received in claim 1, wherein said elastomeric material is transparent.

9. The device recited in claim 1 wherein said opposite surface comprises a smooth rounded surface.

10. The device recited in claim 1 wherein said elastomeric portion comprises a semispherical shape.

11. An earring and earring retainer element combination said earring comprising an ornamental element and a post, said retainer element comprising a substantially solid exterior outer capsule and an interior metallic engagement element, and said outer capsule comprising a piece from an elastomeric material, said capsule having an interior passage, said passage having a gripping axis and said post retained by both said interior and said gripping axis and said post terminating within said outer capsule.

12. The device recited in claim 1, wherein said elastomeric material has a Shore A durometer value of between 25 and 90.

13. A method of retaining an earring comprising the steps of inserting an earring post through an opening in an ear, inserting said post into the composite earring retainer, causing a metallic resilient member to be displaced from a relaxed position to a flexed position and to engage said post and causing said tubular passage to expand in a radial direction wherein said tubular passage exerts a frictional gripping force on said post, wherein said post terminates within said capsule.
